(19) United States
(12) Patent Application Publication
(10) Pub. No.: US 2014/0142807 A1
(43) Pub. Date: May 22, 2014

(54) ACTIVE CONTROL SYSTEM AND METHOD FOR CONTROLLING ACCELERATOR PEDAL EFFORT

(71) Applicants: HYUNDAI MOTOR COMPANY, Seoul (KR); KIA MOTORS CORPORATION, Seoul (KR)

(72) Inventors: Jeong Seon Min, Gwangju (KR); Eun Sik Kim, Gwangmyeong (KR); Jeong Seop Lee, Seoul (KR); Yang Rae Cho, Suwon (KR)

(73) Assignees: Kia Motors Corporation, Seoul (KR); Hyundai Motor Company, Seoul (KR)

(21) Appl. No.: 13/841,213

(22) Filed: Mar. 15, 2013

(30) Foreign Application Priority Data
Nov. 21, 2012 (KR) 10-2012-0132140

(51) Int. Cl. G05G 1/40

(52) U.S. Cl. CPC G05G 1/40
USPC 701/36

(57) ABSTRACT

An active control method of a pedal effort of an accelerator pedal is disclosed, in which the pedal effort of the accelerator pedal is varied actively in accordance to whether or not the vehicle is driving in the rain. More specifically, a processor is configured to determine whether a vehicle is driving in rain via shifting stage input signals and an input signal from a rain sensor when the vehicle turns on; and then increase a current pedal effort of the accelerator pedal to a preset pedal effort when the vehicle is determined to be in rain-driving state.

### CROSS-REFERENCE TO RELATED APPLICATION

This application claims under 35 U.S.C. §119(a) the benefit of Korean Patent Application No. 10-2012-0132140 filed Nov. 21, 2012 the entire contents of which are incorporated herein by reference.

### BACKGROUND

(a) Technical Field

The present disclosure relates to an active control system and method for controlling pedal effort of an accelerator pedal apparatus, and more particularly, to an active control system and method for controlling pedal effort of an accelerator pedal apparatus driving in the rain.

(b) Background Art

FIG. 1 is a perspective view illustrating an accelerator pedal apparatus for a vehicle which has an organ type assembly which includes a pedal arm housing 1 that is fixed to a vehicle body panel at a lower part of a driver seat, a pedal arm 2 one end of which is coupled rotatably to the pedal arm housing 1, a pedal bracket 3 that is fixed to a floor panel at a lower part of the driver seat, and a pedal pad 4 one end of which is hinge-coupled rotatably to the pedal bracket 3 and which is ball-jointed to the pedal arm 2. Here, a spring plate 5 is coupled to one end of the pedal arm 2 disposed inside the pedal arm housing 1 and one end of a spring 6 is supported on the spring plate 5 and the other end of the spring 6 is supported on the pedal arm housing 1.

Accordingly, in the accelerator pedal apparatus shown in FIG. 1, the spring 6 is compressed elastically to provide pedal effort to the pedal pad 4 when the pedal arm 2 rotates with respect to the pedal arm housing 1 through a hinge shaft 7. However, in this accelerator pedal apparatus, since the spring 6 is preset in advance with an elastic coefficient to meet safety regulations prescribed based on each countries specific regulations, the pedal effort cannot be adjusted unless the spring is replaced with new one. Currently, there is no way to vary actively the pedal effort to account for safe rain driving and thus there is a great need for this solution in the industry.

Furthermore, it should be noted that the description provided above is merely for aiding in understanding of the background of the present invention and should not be construed as admitted prior art.

### SUMMARY OF THE DISCLOSURE

The present invention has been made in an effort to solve the above-described problems associated with prior art and it is an object of the present invention relates to provide an active control system and method of a pedal effort of an accelerator pedal through which a rain-driving state is determined in an accelerator pedal apparatus configured to vary the pedal effort accordingly, using a shifting input signal of a vehicle and a signal from a rain sensor, and the pedal effort can be varied actively in proportion to rainfall amount when the vehicle is in the rain-driving state.

In order to achieve the object of the present invention, the present invention provides an active control system and method of a pedal effort of an accelerator pedal including; a determining, by a processor in a controller installed in the vehicle, whether a vehicle is driving in the rain using shifting stage input signals and an input signal from a rain sensor when the vehicle turns on; and increasing, by the processor in the controller, a current pedal effort of the accelerator pedal to a preset pedal effort when the vehicle is determined to be in a rain-driving state.

The control method of a pedal effort of an accelerator pedal of the present invention may further include determining, by the processor within the controller, whether a pedal effort adjusting system is in a normal state when the vehicle turns on prior to determining whether the vehicle is driving in rain. Furthermore, when the vehicle is determined as not being in the rain-driving state, the current pedal effort of the accelerator pedal may be maintained in an initial pedal effort state.

In some exemplary embodiments of the present invention, the system may be configured to determine whether the vehicle is driving in the rain only when the pedal effort adjusting system is in a normal state and when the pedal effort adjusting system is in an abnormal state, the current pedal effort of the accelerator pedal is maintained in an initial pedal effort state.

The pedal effort adjusting system may be determined to be in a normal state only when a voltage signal of a battery is normal, there is no request signal for initializing the system in accordance with an emergency state and a signal of an active adjusting mode of pedal effort is generated.

Even further, in some exemplary embodiments of the present invention, the vehicle may be determined to be in the rain-driving state only when the shifting stage input signal is in a D stage and there is input signal from the rain sensor. Furthermore, the pedal effort of an accelerator pedal may be increased in proportion to rainfall amount detected in the rain sensor.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a perspective view illustrating an accelerator pedal apparatus not provided with a pedal effort adjusting function according to a related art;

FIGS. 2 to 5 are views illustrating an accelerator pedal apparatus provided with a pedal effort adjusting function according to the exemplary embodiment of the present invention, respectively; and

FIG. 6 is a flow chart illustrating a method for adjusting actively the pedal effort, using an accelerator pedal apparatus provided with a pedal effort adjusting function according to the exemplary embodiment of the present invention.

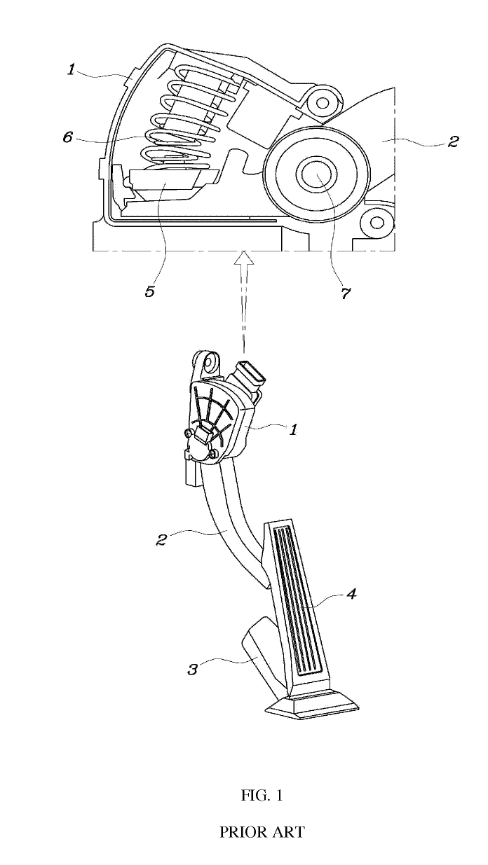

It should be understood that the appended drawings are not necessarily to scale, presenting a somewhat simplified representation of various preferred features illustrative of the basic principles of the invention.

In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, preferred embodiments of the present invention will be described referring to the accompanying drawings.

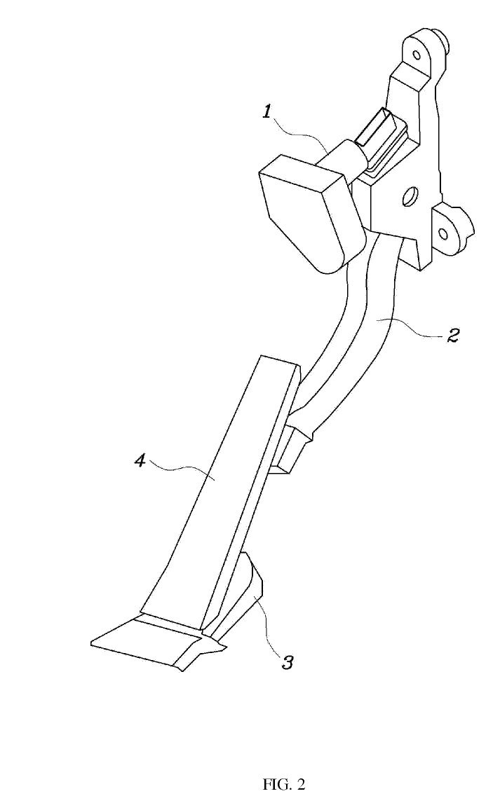

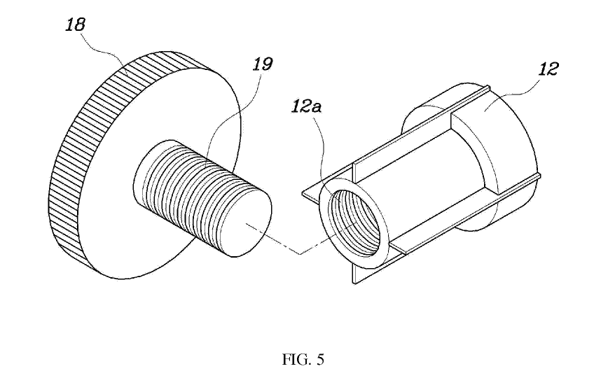

The accelerator pedal apparatus for a vehicle provided with a pedal effort adjusting function according to the present invention, as shown in FIGS. 2 to 5, may include a pedal arm housing 1 that is fixed to a vehicle body panel in front of a driver seat, a pedal arm 2 one end of which is coupled rotatably to the pedal arm housing 1, a pedal bracket 3 that is fixed to a floor panel in front of the driver seat, and a pedal pad 4 one end of which is hinge-coupled rotatably to the pedal bracket 3 and which is ball-jointed to the pedal arm 2. Meanwhile, a spring plate 5 is coupled to one end of the pedal arm 2 disposed inside the pedal arm housing 1 and the pedal arm 2 rotates with respect to the pedal arm housing 1 through a hinge shaft 7.

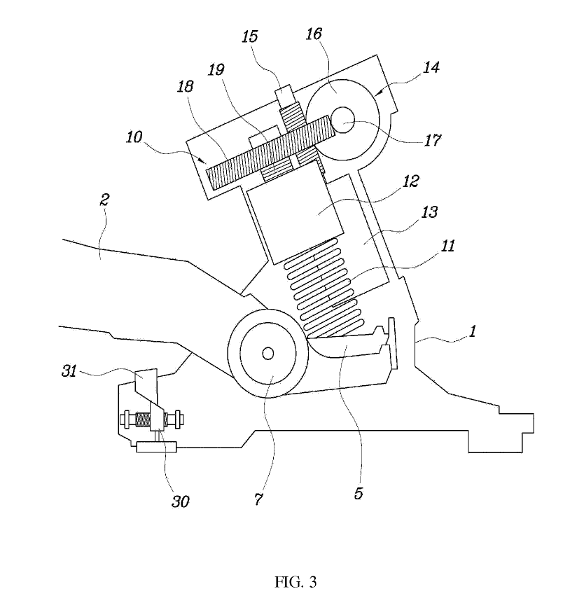

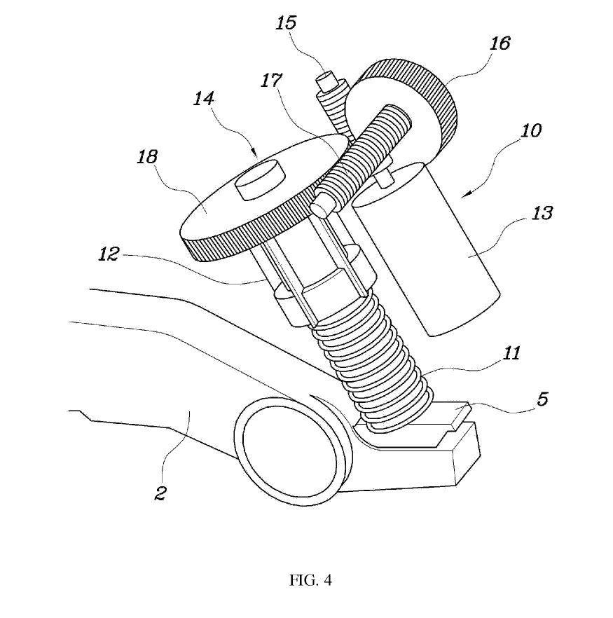

The accelerator pedal apparatus according to the present invention may be provided with a pedal effort adjusting module 10 wherein the pedal effort adjusting module may include: a spring 11 one end of which is supported on one end of the pedal arm 2 disposed inside the pedal arm housing 1; a spring fixing block 12 that is arranged to support the other end of the spring 11; a motor 13 that is fixed to the pedal arm housing 1; and a power transmission mechanism 14 that transmits power from the motor 13 to the spring fixing block 12 and moves the spring fixing block 12 for a length of the spring 11 to be varied. Here, the spring 11 may be arranged to be supported directly on one end of the pedal arm 2, or as shown in FIGS. 3 and 4, it may be arranged so that the spring plate 5 is coupled to one end of the pedal arm 2 disposed inside the pedal arm housing 1 and a lower end of the spring 11 is supported on the spring plate 5. Accordingly, when the pedal arm 2 rotates around the hinge shaft 7, the spring 11 may be compressed elastically between the spring plate 5 and the spring fixing block 12 and a pedal effort may be provided to the pedal pad 4 through the pedal arm 2 during the elastic compression of the spring.

The power transmission mechanism 14 may be arranged to couple the motor 13 and the spring fixing block 12 to transmit power from the motor 13 to the spring fixing block 12. Additionally, it may include a first worm gear 15 coupled integrally to a shaft of the motor 13, a first worm wheel gear 16 that is meshed with the first worm gear 15 to be rotated, a second worm gear 17 coupled integrally to a center of the first worm wheel gear 16, a second worm wheel gear that is meshed with the second worm gear 17 to be rotated, and a gear ball 19 which protrudes integrally from a center of the second worm wheel gear 16 and on an outer peripheral surface of which a plurality of screw grooves are formed.

Furthermore, a plurality of coupling grooves 12a processed with screw grooves may be formed on an inner peripheral surface of the spring fixing block 12, into which a gear bolt 19 is screw-fastened. When the second worm wheel gear 18 rotates, the spring fixing block 12 is moved linearly along the gear bolt 19 so that a length of the spring 11 can be varied by a movement of the spring fixing block 12 to vary pedal effort of the accelerator pedal. The operation of the motor 13 may be controlled by a controller (not shown) that is includes a processor configured in accordance with a driving condition, a driver condition and driving inclination, etc.

In the accelerator pedal apparatus provided with a pedal effort adjusting module 10 according to the present invention, the pedal effort can be varied actively via program instructions in a processor in the controller in accordance with a driving mode and a parking mode of a vehicle.

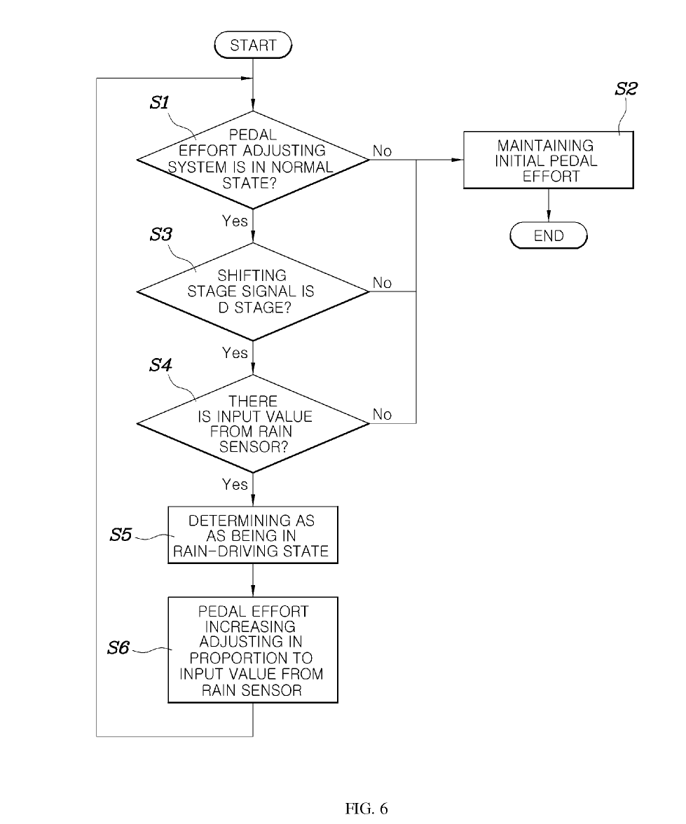

That is, the active control system and method for controlling pedal effort of an accelerator pedal apparatus according to the present invention may include: as shown in FIG. 6, determining, by a processor within a controller installed in the vehicle, whether a pedal effort adjusting system is in a normal state when a vehicle is turned on; in response to determining that the pedal effort adjusting system is in a normal state, determining whether the vehicle is driving in the rain via a shifting stage input signal and a rain sensor input signal; and increasing, by the processor, a current pedal effort of an accelerator pedal to a preset pedal effort when the vehicle is in a rain-driving state.

More specifically, the illustrative embodiment of the present invention may be configured to determine whether or not the vehicle is driving in the rain only when the system is determined as being in a normal state. In particular, the system may be determined to be in a normal state when a voltage signal of a battery is normal, there is no request signal for initializing the system in accordance with an emergency state and a signal of a pedal effort actively adjusting mode is generated.

Furthermore, when the pedal effort adjusting system is determined to be in an abnormal state, the current accelerator pedal effort is maintained in an initial pedal effort state, and further the current accelerator pedal effort is maintained in an initial pedal effort state when the vehicle is determined to be driving in the rain. Here, the initial pedal effort state refers to a pedal effort reset state.

More specifically, the exemplary embodiment of the present invention may determine that the vehicle is driving in the rain only when the shifting stage input signal is in a D (driving) stage and a signal is input from the rain sensor. That is, even though the signal is input from the rain sensor (even when it rains), when the shifting stage is not on the D stage, it is determined that the vehicle is not in a driving state, and in this case it is not necessary to increase the pedal effort of the accelerator pedal.

Furthermore, the pedal effort of the accelerator pedal may be adjusted to increase in proportion to the rainfall amount detected with the rain sensor. That is, as rain falls more, the pedal effort is adjusted further to increase and in this case levels are set in accordance with the rainfall amount and the pedal effort may be increased in stages using the set levels.

Hereinafter, an operation of the exemplary embodiment of the present invention will be described.

In particular, a motor 13 may be operated via program instructions executed by a processor configured with such instructions on a controller. In particular, power from the motor 13 is transmitted to the spring fixing block 12 through the worm gears 15, 17, the worm wheel gears 16, 18, and the gear bolt 19, and then the spring fixing block 12 is raised or lowered along the gear bolt 19 from a state in FIG. 3. When the spring block 19 is raised along the bear bolt 19 (to a receding direction from the spring plate), the spring 11 is varied by elastic recovery force such that its entire length becomes longer and at this time a spring force applying to the pedal arm 2 is reduced and thus the pedal effort of the accelerator pedal is decreased. On the contrary, when the spring block 19 is lowered along the bear bolt 19 (to an approaching direction to the spring plate), the spring 11 is compressed for its entire length to become shorter and at this time a spring force applying to the pedal arm 2 is increased and thus the pedal effort of the accelerator pedal is increased.

The motor 13 may be operated automatically via program instructions executed by a controller (not shown) wherein as an example, it may be operated to increase the pedal force on the parking mode thereby preventing easily increasing the speed of the vehicle and making it possible for the vehicle to be easily slowed down and further to decrease the pedal effort on the parking mode thereby reducing the fatigue in accordance with an operation of the accelerator pedal.

Further, the fatigue in accordance with an operation of the accelerator pedal may be reduced by adjusting the pedal effort to be decreased while a vehicle drives at lower velocities (city driving), or ankle fatigue may be reduced by adjusting the pedal effort to be increased and helping the pedal to be supported constantly while a vehicle is driving at a higher velocities (express way driving).

Further, the pedal effort may be decreased when climbing uphill to increase the amount the pedal is operated and be increased on a when traveling downhill to decrease the amount the pedal is operated. In addition, the pedal effort may be increased for safety while a vehicle is driving over certain velocity or in a safety mode, and further the pedal effort may be adjusted properly in considering of age, sex and condition of a driver.

Next, an active control method of varying a pedal effort in accordance with the rain-driving or not will be described.

A controller may be configured to determine whether a pedal effort adjusting system is in a normal state when a vehicle is turned on (Step S1). More specifically, the pedal adjusting system may be determined as being in a normal state when a voltage signal of a battery is in a normal state, there is no request signal for initializing the system in accordance with an emergency state and a signal of an active adjusting mode of pedal effort is generated. Here, when the voltage signal of a battery is less than 9V or exceeds to 16.5V, the pedal effort adjusting system is determined as being in a normal state. The pedal effort of the accelerator pedal is reset to the initial state (S2) when the pedal effort adjusting system is determined as being in an abnormal state.

When the pedal effort adjusting system is determined as being in a normal state, the controller may determine whether the shifting stage input signal is in a D stage (Step S3), and when the shifting stage input signal is determined to be in the D stage, the controller may determine whether there is input signal from the rain sensor (Step S4). A rain sensor may be any sensor well known in the art that is configured to send one or more signals to any one of a plethora of controllers installed in the vehicle upon detecting rain.

At this time, the controller may be configured to determine that the vehicle is in the rain-driving state (S5) when the shifting stage input signal is in a D stage, and further there is an input value from the rain sensor. However, the controller may determine that the vehicle is not in the rain-driving state when the shifting stage input signal is in any other stage except for the D stage, or there is no input value from the rain sensor, and in this case the controller may be configured to reset the current pedal effort of an accelerator pedal to an initial pedal effort state. When the vehicle is determined as being in a rain-driving state, the controller controls the motor 13 for compressing the spring 13 such that the length of the spring becomes shorter, and as a result the spring force applied to the pedal arm 2 increases to increase a current pedal effort of an accelerator pedal in proportion to input value of the rain sensor (Step S16).

According to the accelerator pedal apparatus of the present invention as described above, a length of the spring 11 can be varied by a movement of the spring fixing block 12 in accordance with an operation of the motor 13 without replacing separately other components, and as a result the pedal effort can be varied easily, if necessary, to fully meet the safety regulations with respect to the pedal effort of the accelerator pedal regardless of the specific type of vehicle in which it is installed. According to the active control system and method of a pedal effort of an accelerator pedal of the present invention, the pedal effort of an accelerator pedal can be actively varied when a vehicle is driving in the rain thereby improving greatly convenience and safety of a user.

While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

What is claimed is:

1. An active control method of a pedal effort of an accelerator pedal comprising;
determining, by a processor within a controller installed in the vehicle, whether a vehicle is driving in rain via shifting stage input signals and an input signal from a rain sensor when the vehicle turns on; and
increasing, by the processor, a current pedal effort of the accelerator pedal to a preset pedal effort when the vehicle is determined to be in rain-driving state.

2. The active control method of a pedal effort of an accelerator pedal according to claim 1, further comprising determining whether a pedal effort adjusting system is in a normal state when the vehicle turns on prior to determining whether the vehicle is driving in rain.

3. The active control method of a pedal effort of an accelerator pedal according to claim 1, wherein when the vehicle is determined to not being in the rain-driving state, the current pedal effort of the accelerator pedal is maintained in an initial pedal effort state.

4. The active control method of a pedal effort of an accelerator pedal according to claim 2, wherein determining whether the vehicle is driving in the rain is performed only when the pedal effort adjusting system is in a normal state and when the pedal effort adjusting system is determined in an abnormal state, the current pedal effort of the accelerator pedal is maintained in an initial pedal effort state.

5. The active control method of a pedal effort of an accelerator pedal according to claim 2, wherein the pedal effort adjusting system is determined as being in the normal state only when a voltage signal of a battery is normal, there is no request signal for initializing the system in accordance with an emergency state and a signal of an active adjusting mode of pedal effort is generated.

6. The active control method of a pedal effort of an accelerator pedal according to claim 1, further comprising determining that the vehicle is in the rain-driving state only when the shifting stage input signal is in a D stage and there is an input signal from the rain sensor.

7. The active control method of a pedal effort of an accelerator pedal according to claim 1, wherein the pedal effort of an accelerator pedal is increased in proportion to rainfall amount detected in the rain sensor.

8. A non-transitory computer readable medium containing program instructions executed by a processor or controller, the computer readable medium comprising:
program instructions that determine whether a vehicle is driving in rain via shifting stage input signals and an input signal from a rain sensor when the vehicle turns on; and
program instructions that increase a current pedal effort of an accelerator pedal to a preset pedal effort when the vehicle is determined to be in rain-driving state.

9. The non-transitory computer readable medium according to claim 8, further comprising program instructions that determine whether a pedal effort adjusting system is in a normal state when the vehicle turns on prior to determining whether the vehicle is driving in rain.

10. The non-transitory computer readable medium according to claim 8, wherein when the vehicle is determined to not being in the rain-driving state, the current pedal effort of the accelerator pedal is maintained in an initial pedal effort state.

11. The non-transitory computer readable medium according to claim 9, wherein determining whether the vehicle is driving in the rain is performed only when the pedal effort adjusting system is in a normal state and when the pedal effort adjusting system is determined in an abnormal state, the current pedal effort of the accelerator pedal is maintained in an initial pedal effort state.

12. The non-transitory computer readable medium according to claim 9, wherein the pedal effort adjusting system is determined as being in the normal state only when a voltage signal of a battery is normal, there is no request signal for initializing the system in accordance with an emergency state and a signal of an active adjusting mode of pedal effort is generated.

13. The non-transitory computer readable medium according to claim 8, further comprising program instructions that determine that the vehicle is in the rain-driving state only when the shifting stage input signal is in a D stage and there is an input signal from the rain sensor.

14. The non-transitory computer readable medium according to claim 8, wherein the pedal effort of an accelerator pedal is increased in proportion to rainfall amount detected in the rain sensor.
